(19) United States
(12) Patent Application Publication
(10) Pub. No.: US 2010/0191938 A1
(43) Pub. Date: Jul. 29, 2010

(54) INFORMATION PROCESSING DEVICE, ARITHMETIC PROCESSING METHOD, ELECTRONIC APPARATUS AND PROJECTOR

(75) Inventors: Hiroshi HASEGAWA, Chino-shi (JP); Fumio KOYAMA, Shiojiri-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/696,299

(22) Filed: Jan. 29, 2010

(30) Foreign Application Priority Data
Jan. 29, 2009 (JP) 2009-017703

(51) Int. Cl. G06F 9/302; G06F 9/30; G06F 9/305

(52) U.S. Cl. 712/208; 712/221; 712/223; 712/E09.017; 712/E09.018; 712/E09.028

(57) ABSTRACT

An information processing device including: a first arithmetic processing unit performing first arithmetic processing; a second arithmetic processing unit performing second arithmetic processing; input registers adapted to include a first input register allocated to the first arithmetic processing unit, and a second input register allocated to the second arithmetic processing unit; and output registers storing a processing results of the first arithmetic processing unit and a processing results of the second arithmetic processing unit, in each of given execution cycles, the first arithmetic processing unit performs the first arithmetic processing using stored data of the first input register and stores a processing result of the first arithmetic processing in the output registers and the second arithmetic processing unit performs the second arithmetic processing using stored data of the second input register and stores a processing result of the second arithmetic processing in the output registers.

### CROSS-REFERENCE

The entire disclosure of Japanese Patent Application No. 2009-017703 filed Jan. 29, 2009 is expressly incorporated by reference herein.

### BACKGROUND

1. Technical Field

The present invention relates to an information processing device, an arithmetic processing method, an electronic apparatus, and the like.

2. Related Art

In recent years, a microprocessor (in a broad sense, an information processing device) is incorporated in every apparatus in daily use. The microprocessor is required to be small in size, low in cost, low in power consumption, high in function, and high in performance. Various techniques for realizing increases in function and performance of the microprocessor have been examined. As one of the techniques, there is a method of reducing an instruction set of the microprocessor.

The method of reducing the instruction set is equivalent to a technical idea of RISC (Reduced Instruction Set Computer) architecture with respect to a microprocessor having CISC (Complex Instruction Set Computer) architecture. In other words, instructions to be decoded are limited to simple ones and simplified by reducing the instruction set to realize an increase in speed.

When the instruction set is reduced, the number of bits of an operation code representing an instruction. Then, there are advantages that the number of bits for designating a register called, for example, operand can be increased to increase the number of registers and arithmetic processing and branching processing can be increased in speed because a maximum value that can be embedded in an instruction as an immediate value is increased.

On the other hand, when the instruction set is reduced, the number of steps increases when it is attempted to realize processing same as that of the microprocessor of the CISC architecture. Moreover, it is difficult to improve code efficiency when instruction length is reduced.

Therefore, to further increase speed of processing, it is conceivable to realize an increase in speed of an arithmetic processing unit itself. A technique for increasing the speed of the arithmetic processing unit is disclosed in, for example, JP-A-5-250318. JP-A-5-250318 discloses a technique for analyzing that numerical operation performed via an accumulator is a cause of a fall in processing speed and immediately performing transfer between the accumulator and a general-purpose register without using a transfer instruction to realize an increase in speed of arithmetic operation.

However, with the technique disclosed in JP-A-5-250318, although the transfer instruction can be omitted, leading to slight improvement of efficiency, since an instruction set does not essentially change, code efficiency cannot be improved. Moreover, since a new transfer path is necessary, it is necessary to allocate a new transfer instruction to the instruction set and, for example, the number of bits allocated to an immediate value decreases.

### SUMMARY

An advantage of some aspects of the invention is to provide an information processing device, an arithmetic processing method, an electronic apparatus, and the like that improve code efficiency of an instruction set.

(1) According to an aspect of the invention, there is provided an information processing device including: a first arithmetic processing unit performing first arithmetic processing; a second arithmetic processing unit performing second arithmetic processing;

input registers adapted to include a first input register allocated to the first arithmetic processing unit, and a second input register allocated to the second arithmetic processing unit; and output registers storing a processing results of the first arithmetic processing unit and a processing results of the second arithmetic processing unit, in each of given execution cycles, the first arithmetic processing unit performs the first arithmetic processing using stored data of the first input register and stores a processing result of the first arithmetic processing in the output registers and the second arithmetic processing unit performs the second arithmetic processing using stored data of the second input register and stores a processing result of the second arithmetic processing in the output registers.

In this aspect of the invention, in the information processing device including the first arithmetic processing unit and the second arithmetic processing unit, the first input register among the input registers is allocated to the first arithmetic processing unit and the second input register among the input registers is allocated to the second arithmetic processing unit. In each of the given execution cycles, the first arithmetic processing unit performs the first arithmetic processing using the stored data of the first input register and stores a processing result of the first arithmetic processing in the output registers and the second arithmetic processing unit performs the second arithmetic processing using the stored data of the second input register and stores a processing result of the second arithmetic processing in the output registers. Consequently, in each of execution cycles, results obtained by performing the arithmetic processing using the stored data of the input registers are repeatedly stored in the output registers. Only a data transfer instruction for setting data in the input registers and acquiring data from the output registers is used and an instruction for designating the first arithmetic processing and an instruction for designating the second arithmetic processing are made unnecessary. This makes it possible to realize an information processing device having extremely high code efficiency.

(2) It is preferable that the output registers included: a first output register allocated to the first arithmetic processing unit, and a second output register allocated to the second arithmetic processing unit, the first arithmetic processing unit stores a processing result of the first arithmetic processing in the first output register and the second arithmetic processing unit stores a processing result of the second arithmetic processing in the second output register. According to this invention, the first output register among the output registers is allocated to the first arithmetic processing unit and the second output register among the output registers is allocated to the second arithmetic processing unit. The processing results output from the first arithmetic processing unit and the second arithmetic result are respectively transferred to the corresponding output registers. In general, a result of the operation is stored in the general-purpose resistor. Therefore, such a result should be transferred to another resistor or slower storage. However, in this invention, each of the arithmetic processing unit has the allocated output resistor and respectively transmits the result of the operation to the corresponding output resistor. As a result, the program to be executed on the information processing device becomes extremely simple.

(3) It is preferable that the information processing device further includes an instruction decoding unit that decodes fetched instruction data, and irrespectively of a decoding result of the instruction decoding unit, in each of the execution cycles, the first arithmetic processing unit and the second arithmetic processing unit store arithmetic operation results of the arithmetic processing units in the output registers corresponding thereto. This makes it possible to store the processing results of the arithmetic processing units in the output registers corresponding thereto in each of the execution cycles irrespectively of a decoding result of the instruction decoding unit. As a result, it is possible to acquire a result of the first arithmetic processing and a result of the second arithmetic processing at a time and realize an increase in speed of the arithmetic processing.

(4) It is preferable that the instruction decoding unit decodes a data transfer instruction and a branch instruction excluding an arithmetic operation instruction, a logical operation instruction, and a shift operation instruction. This makes it possible to give a margin to a bit field specified by an instruction set and provide an information processing device having extremely high code efficiency. As a result, it is possible to increase difficulty in reading a code, make disassemble difficult to generate a code with high security, and contribute to reverse engineering prevention and improvement of security.

(5) It is preferable that the stored data of the first output register or the stored data of the second output register is formed to be transferable to any one of the input registers. This makes it possible to serve results of the arithmetic processing performed by the first arithmetic processing unit and the second arithmetic processing unit to the arithmetic processing again and perform processing such as branch processing using the arithmetic processing results even if an instruction for designating the arithmetic processing is not issued.

(6) It is preferable that the first input register is allocated to the second arithmetic processing unit, and the second arithmetic processing unit performs, in each of the execution cycles, the second arithmetic processing using the stored data of the first input register and stores a processing result of the second arithmetic processing in the second output register. This makes it possible perform, in performing plural kinds of arithmetic processing using data set in one input register, the plural kinds of arithmetic processing at a time and realize an increase in speed of processing.

(7) It is preferable that the first arithmetic processing unit or the second arithmetic processing unit performs any one kind of arithmetic processing among addition, multiplication, subtraction, logical operation, and shift operation. This makes it possible to provide an information processing device that can acquire any one kind of arithmetic processing among addition, multiplication, subtraction, logical operation, and shift operation irrespectively of an instruction set in which an addition instruction, a multiplication instruction, a subtraction instruction, a logical operation instruction, and a shift operation instruction are omitted.

(8) It is preferable that the first arithmetic processing unit and the second arithmetic processing unit include arithmetic logical operation units having the same configuration. This makes it possible to provide an information processing device that can obtain an arithmetic operation result with high flexibility in addition to the effects explained above.

(9) It is preferable that the input registers are general-purpose registers. This makes it possible to provide an information processing device having extremely high code efficiency without providing a special register exclusively used for the arithmetic processing units.

(10) It is preferable that the output registers are accumulators. This makes it possible to provide an information processing device having extremely high code efficiency without providing a special register exclusively used for the arithmetic processing units.

(11) It is preferable that the first arithmetic processing unit and the second arithmetic processing unit are configured to be operable in parallel to each other. This makes it possible to provide an information processing device having high processing efficiency that can simultaneously perform plural arithmetic operations.

(12) According to another aspect of the invention, there is provided an arithmetic processing method for an information processing device including: a first arithmetic processing unit that performs first arithmetic processing; a second arithmetic processing unit that performs second arithmetic processing; input registers including a first input register and a second input register; and output registers in which a processing result of the first arithmetic processing unit and a processing result of the second arithmetic processing unit are stored, the arithmetic processing method including: allocating the first input register to the first arithmetic processing unit, and allocating the second input register to the second arithmetic processing unit, in each of given execution cycles, the first arithmetic processing unit performing the first arithmetic processing using stored data of the first input register and storing a processing result of the first arithmetic processing in the output registers and the second arithmetic processing unit performing the second arithmetic processing using stored data of the second input register and storing a processing result of the second arithmetic processing in the output registers.

With the aspect of the invention, in each of execution cycles, results obtained by performing the arithmetic processing using the stored data of the input registers are repeatedly stored in the output registers. Only a data transfer instruction for setting data in the input registers and acquiring data from the output registers is used and an instruction for designating the first arithmetic processing and an instruction for designating the second arithmetic processing are made unnecessary. This makes it possible to provide an arithmetic processing method for an information processing device having extremely high code efficiency.

(13) It is preferable that the arithmetic processing method according to the invention further includes, providing the output registers adapted to include a first output register and a second output register, allocating the first output register to the first arithmetic processing unit, and allocating the second output register to the second arithmetic processing unit, the first arithmetic processing unit storing a processing result of the first arithmetic processing in the first output register and the second arithmetic processing unit storing a processing result of the second arithmetic processing in the second output register. The processing results output from the first arithmetic processing unit and the second arithmetic result are respectively transferred to the corresponding output registers. In general, a result of the operation is stored in the general-purpose resistor. Therefore, such a result should be transferred to another resistor or slower storage. However, in this invention, each of the arithmetic processing unit has the allocated output resistor and respectively transmits the result of the operation to the corresponding output resistor. As a result, the program to be executed on the information processing device becomes extremely simple.

(14) It is preferable that the arithmetic processing method according to the invention is applied to an arithmetic processing device in which, irrespectively of a decoding result of fetched instruction data, in each of the execution cycles, the first arithmetic processing unit and the second arithmetic processing unit store arithmetic operation results of the arithmetic processing units in the output registers corresponding thereto. This makes it possible to store the processing results of the arithmetic processing units in the output registers corresponding thereto in each of the execution cycles irrespectively of a decoding result of the instruction decoding unit. As a result, it is possible to acquire a result of the first arithmetic processing and a result of the second arithmetic processing at a time and realize an increase in speed of the arithmetic processing.

(15) It is preferable that the arithmetic processing method according to the invention is applied to an arithmetic processing device in which the instruction data is instruction data corresponding to a data transfer instruction and a branch instruction excluding an arithmetic operation instruction, a logical operation instruction, and a shift operation instruction. This makes it possible to give a margin to a bit field specified by an instruction set and provide an arithmetic processing method for an information processing device having extremely high code efficiency. As a result, it is possible to increase difficulty in reading a code, make disassemble difficult to generate a code with high security, and contribute to reverse engineering prevention and improvement of security.

(16) It is preferable that the arithmetic processing method according to the invention is applied to an arithmetic processing device in which the input registers are general-purpose registers. This makes it possible to provide an arithmetic processing method for an information processing device having extremely high code efficiency without providing a special register exclusively used for the arithmetic processing units.

(17) It is preferable that the arithmetic processing method according to the invention is applied to an arithmetic processing device in which the output registers are accumulators. This makes it possible to provide an arithmetic processing method for an information processing device that can obtain an arithmetic operation result with high flexibility in addition to the effects explained above.

(18) It is preferable that the arithmetic processing method according to the invention is applied to an arithmetic processing device in which the first arithmetic processing unit and the second arithmetic processing unit are configured to be operable in parallel to each other. This makes it possible to provide an arithmetic processing method for an information processing device having high processing efficiency that can simultaneously perform plural arithmetic operations.

(19) According to still another aspect of the invention, there is provided an electronic apparatus including: a memory that stores a computer program and data; and the information processing device according to any one of the aspects that performs arithmetic processing corresponding to the computer program and the data.

According this aspect, it is possible to provide an electronic apparatus that can improve code efficiency of an instruction set, increase difficulty in reading a code, make disassemble difficult to generate a code with high security, and, on the other hand, perform reverse engineering prevention and improvement of security.

(20) Furthermore, it is possible to provide a projector including a projecting unit that projects an image corresponding to inputted image data, comprising, including: a memory that stores a computer program and data, and the image processing device includes the information processing device according to any one of the aspects that performs arithmetic processing corresponding to the computer program and the data.

According to this aspect, it is possible to provide an projector that can improve code efficiency of an instruction set, increase difficulty in reading a code, make disassemble difficult to generate a code with high security, and, on the other hand, perform reverse engineering prevention and improvement of security.

### BRIEF DESCRIPTION OF THE DRAWINGS

The invention will be described with reference to the accompanying drawings, wherein like numbers reference like elements.

FIG. 1 is a diagram of a principle configuration example of an information processing device according to an embodiment of the invention.

FIG. 2 is a block diagram of a configuration example of a CPU as the information processing device shown in FIG. 1.

FIG. 3 is a diagram for explaining instruction data of a computer program read by the CPU shown in FIG. 2.

FIG. 4 is a diagram of a configuration example of a general-purpose register unit shown in FIG. 2.

FIG. 5 is a diagram of a configuration example of an accumulator unit shown in FIG. 2.

FIG. 6 is a block diagram of a detailed configuration example of the general-purpose register unit, an arithmetic processor, and the accumulator unit according to the embodiment.

FIG. 7 is a diagram for explaining a processing example of the arithmetic processor shown in FIG. 6.

FIGS. 8A and 8B are diagrams for explaining an operation example of the CPU shown in FIG. 2.

FIG. 9 is a diagram for explaining an example of an instruction set of the CPU according to the embodiment.

FIGS. 10A and 10B are diagrams for explaining effects of a code of a computer program executed by the CPU according to the embodiment.

FIG. 11 is a block diagram of a configuration example of an arithmetic processor according to a modification of the embodiment.

FIG. 12 is a block diagram of a configuration example of an image display system including a projector as an electronic apparatus according to the embodiment.

FIG. 13 is a block diagram of a hardware configuration example of an image processing device shown in FIG. 12.

FIG. 14 is a diagram of a configuration example of a projection device shown in FIG. 12.

### DESCRIPTION OF EXEMPLARY EMBODIMENTS

An embodiment of the invention is explained in detail below with reference to the accompanying drawings. The embodiment explained below does not unreasonably limit the content of the invention described in claims. All components explained below are not always essential elements of the invention.

### 1. Information Processing Device

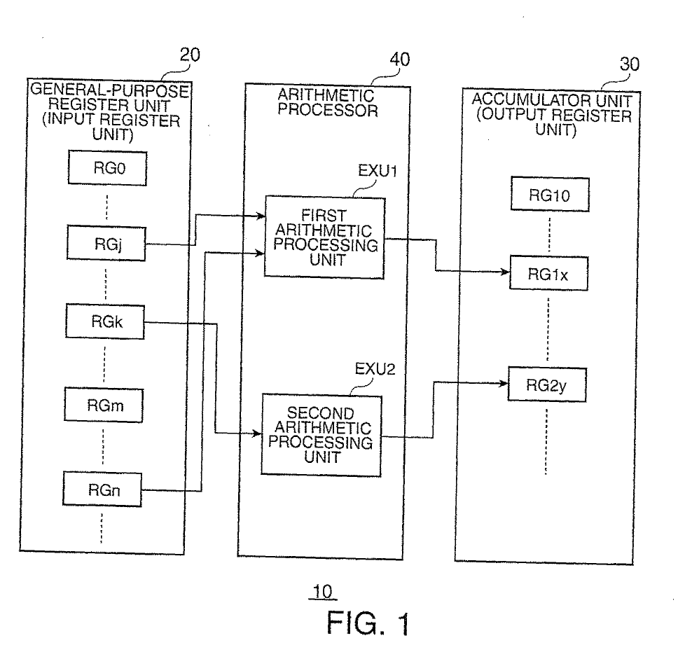

A principle configuration example of an information processing device according to an embodiment of the invention is shown in FIG. 1.

An information processing device 10 according to this embodiment includes a general-purpose register unit 20, an accumulator unit 30, and an arithmetic processor 40.

The general-purpose register unit 20 includes plural general-purpose registers RG0, . . . , RGj, . . . , RGk, . . . , RGm, . . . , RGn, and the like from which stored data can be read out from the outside and in which stored data can be written from the outside. Input data served to arithmetic processing performed by the arithmetic processor 40 is set in the general-purpose register unit 20. The plural general-purpose registers of the general-purpose register unit 20 have a function of an input register in which input data of the arithmetic processor 40 is set.

The accumulator unit 30 includes plural accumulators RG10, . . . , RG1x, . . . , RG2y, and the like in which a processing result of the arithmetic processing performed by the arithmetic processor 40 is stored. The plural accumulators of the accumulator unit 30 have a function of an output register in which a processing result of the arithmetic processor 40 is stored.

The arithmetic processor 40 includes plural arithmetic processing units configured to be operable in parallel to each other. The plural arithmetic processing units may perform different kinds of processing from one another or one arithmetic processing unit may perform arithmetic processing of the same kind as arithmetic processing of the other arithmetic processing units. The arithmetic processing units included in the plural arithmetic processing units of the arithmetic processor desirably perform so-called arithmetic operation, logical operation, or shift operation. The arithmetic operation is desirably any one of addition, multiplication, subtraction, division, increment operation, and decrement operation. The logical operation is desirably any one of OR operation, AND operation, NOT operation, exclusive OR operation, and exclusive NOR operation. The shift operation is desirably any one of logical shift operation, arithmetic shift operation, rotational operation, and swap operation.

One or plural general-purpose registers among the plural general-purpose registers of the general-purpose register unit 20 are allocated to the arithmetic processing units included in the plural arithmetic processing units of the arithmetic processor 40. One or plural accumulators among the plural accumulators of the accumulator unit 30 are also allocated to the arithmetic processing units. In each of given execution cycles, the plural arithmetic processing units simultaneously perform the arithmetic processing using input data set in the general-purpose registers allocated to each of the arithmetic processing units and store processing results of the arithmetic processing in the accumulators allocated to each of the arithmetic processing units.

Specifically, the arithmetic processor 40 includes at least a first arithmetic processing unit EXU1 that performs first arithmetic processing and a second arithmetic processing unit EXU2 that performs second arithmetic processing. Processing content of the first arithmetic processing may be the same as or different from processing content of the second arithmetic processing. The plural general-purpose registers (input registers) include first general-purpose registers (input registers) RGj and RGn allocated to the first arithmetic processing unit EXU1 and a second general-purpose register (input register) RGk allocated to the second arithmetic processing unit EXU2. The plural accumulators (output registers) include a first accumulator (output register) RG1x allocated to the first arithmetic processing unit EXU1 and a second accumulator (output register) RG2y allocated to the second arithmetic processing unit EXU2. In the information processing device 10, in each of the execution cycles, the first arithmetic processing unit EXU1 performs the first arithmetic processing using stored data of the first general-purpose registers RGj and RGn and stores a processing result of the first arithmetic processing in the first accumulator RG1x. The second arithmetic processing unit EXU2 performs the second arithmetic processing using stored data of the second general-purpose register RGk and stores a processing result of the second arithmetic processing in the second accumulator RG2y.

The plural accumulators including the first accumulator RG1x may be allocated to the first arithmetic processing unit EXU1. Similarly, the plural accumulators including the second accumulator RG2y may be allocated to the second arithmetic processing unit EXU2.

Specifically, as an arithmetic processing method of the information processing device 10, a first input register among the plural input registers is allocated to the first arithmetic processing unit EXU1, a second input register among the plural input registers is allocated to the second arithmetic processing unit EXU2, a first output register among the plural output registers is allocated to the first arithmetic processing unit EXU1, and a second output register among the plural output registers is allocated to the second arithmetic processing unit EXU2. In each of the given execution cycles, the first arithmetic processing unit EXU2 performs the first arithmetic processing using stored data of the first input register and stores a processing result of the first arithmetic processing in the first output register. The second arithmetic processing unit performs the second arithmetic processing using stored data of the second input register and stores a processing result of the second arithmetic processing in the second output register.

Such an information processing device 10 repeats, in each of execution cycles, storing a result obtained by performing the arithmetic processing using the stored data of the general-purpose registers in the accumulators. This makes it possible to make an instruction for designating the arithmetic processing unnecessary, give a margin to a bit field specified by an instruction set, and realize an information processing device having extremely high code efficiency.

The stored data of the first accumulator and the stored data of the second accumulator are formed to be transferable to any one of the plural general-purpose registers. Consequently, a result of the arithmetic processing performed by the arithmetic processor 40 can be served to the arithmetic processing again. Therefore, it is possible to perform processing such as branch processing using the arithmetic processing result even if an instruction for designating the arithmetic processing is not issued.

The first general-purpose register may be allocated to the second arithmetic processing unit EXU2. The second arithmetic processing unit EXU2 may perform, in each of the execution cycles, the second arithmetic processing using the stored data of the first general-purpose register and store a processing result of the second arithmetic processing in the second accumulator. Consequently, when plural kinds of arithmetic processing are performed by using data set in one general-purpose register, the arithmetic processing can be performed at a time and an increase in speed of processing can be realized.

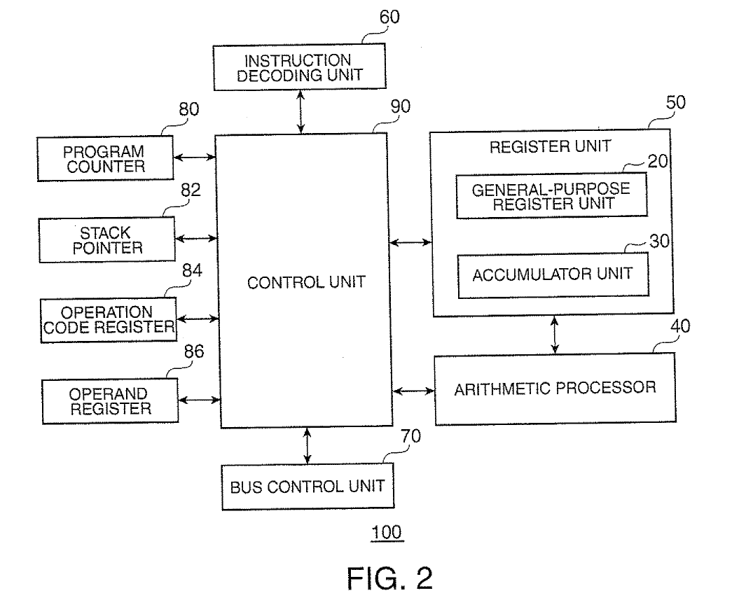

A block diagram of a configuration example of a central processing unit (CPU) as the information processing device 10 shown in FIG. 1 is shown in FIG. 2. In FIG. 2, components same as those shown in FIG. 1 are denoted by the same reference numerals and explanation of the components is omitted as appropriate.

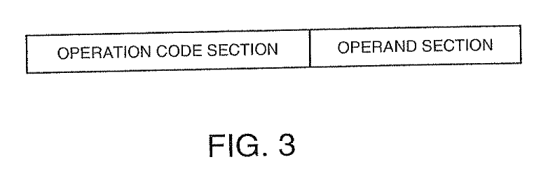

A diagram for explaining instruction data of a computer program read by the CPU 100 shown in FIG. 2 is shown in FIG. 3.

The CPU 100 includes a register unit 50 including the general-purpose register unit 20 and the accumulator unit 30, an instruction decoding unit 60, a bus control unit 70, a program counter (PC) 80, a stack pointer (SP) 82, an operation code register 84, an operand register 86, and a control unit 90.

The CPU 100 reads a computer program stored in a not-shown memory on the outside or the inside of the CPU 100 and executes processing designated by the computer program. The computer program is a sequence of instruction data shown in FIG. 3, each designating processing content of the CPU 100. The instruction data has an operation code section and an operand section. The operation code section is a section for designating the processing content. The operand section is a section for designating a target of the processing designated by the operation code section.

The program counter 80 is a control register that stores an address of a computer program currently executed by the CPU 100. Content of the program counter 80 is updated every time the CPU 100 ends execution of processing. The stack pointer 82 is a control register that stores an address saved in a save area for data, which is called a stack area, last. The stack pointer 82 is used for, for example, suspending present processing when the present processing shifts to sub-routine processing and resuming the suspended processing after the end of the sub-routine processing. The operation code register 84 is a control register that stores an operation code section of instruction data fetched by the CPU 100. The operand register 86 is a control register that stores an operand section of the instruction data fetched by the CPU 100.

When instruction data of a computer program stored in an address designated by the program counter 80 is fetched by the CPU 100, the instruction decoding unit 60 decodes the instruction data and outputs a decoding result to the control unit 90.

The bus control unit 70 performs arbitration control for a bus provided on the outside or the inside of the CPU 100 and performs access control according to an instruction from the control unit 90.

The control unit 90 controls the program counter 80, the stack pointer 82, the operation code register 84, the operand register 86, the bus control unit 70, the arithmetic processor 40, and the register unit 50 on the basis of a decoding result from the instruction decoding unit 60 and manages the control of the CPU 100.

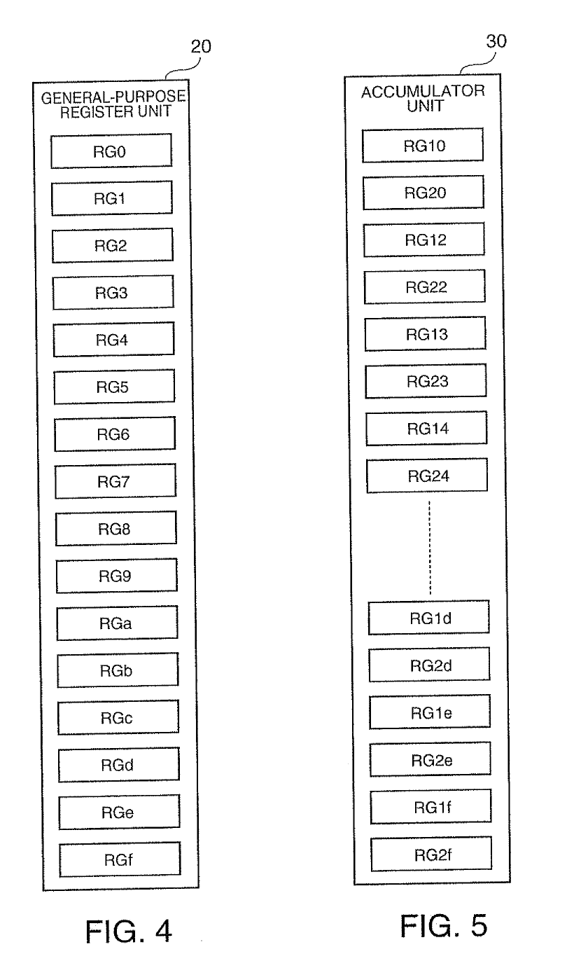

A configuration example of the general-purpose register unit 20 shown in FIG. 2 is shown in FIG. 4.

In this embodiment, the general-purpose register unit 20 includes sixteen kinds of general-purpose registers RG0 to RGf. In this embodiment, the CPU 100 is explained as including sixteen kinds of general-purpose registers. However, the invention is not limited by the number of general-purpose registers. The CPU 100 only has to include plural general-purpose registers. Further, in this embodiment, the number of bits of a general-purpose register is explained as “16”. However, the invention is not limited to this and is not limited by the number of bits of the general-purpose register.

The general-purpose registers shown in FIG. 4 are configured to be accessible from the control unit 90. The control unit 90 can write data in the general-purpose registers and read out data from the general-purpose registers. Any one of the general-purpose registers RG0 to RGf shown in FIG. 2 is allocated in advance to any one of the plural arithmetic processing units of the arithmetic processor 40. Among the general-purpose registers RG0 to RGf, a general-purpose register allocated to none of the plural arithmetic processing units of the arithmetic processor 40 may be present. One general-purpose register may be allocated to the plural arithmetic processing units of the arithmetic processor 40.

A configuration example of the accumulator unit 30 shown in FIG. 2 is shown in FIG. 5.

In this embodiment, the accumulator unit 30 includes thirty-two kinds of accumulators RG10 to RG2f. In this embodiment, the CPU 100 is explained as including thirty-two kinds of accumulators. However, the invention is not limited by the number of the accumulators. The CPU 100 only has to include plural accumulators. Further, in this embodiment, the number of bits of an accumulator is explained as “16”. However, the invention is not limited to this. The invention is not limited by the number of bits of the accumulator.

The accumulators shown in FIG. 5 are configured to be writable from the arithmetic processing units of the arithmetic processor 40. The control unit 90 can read out data written in the accumulators and transfer the data to any one of the general-purpose registers of the general-purpose register unit 20. Any one of the accumulators RG10 to RG2f in FIG. 2 is allocated in advance to any one of the plural arithmetic processing units of the arithmetic processor 40. Among the accumulators RG10 to RG2f, an accumulator allocated to none of the plural arithmetic processing units of the arithmetic processor 40 may be present.

The arithmetic processing units included in the plural arithmetic processing units of the arithmetic processor 40 perform, in each of the execution cycles, the arithmetic processing using data of the general-purpose registers allocated thereto as the input registers and store results of the arithmetic processing in the accumulators allocated thereto as the output registers.

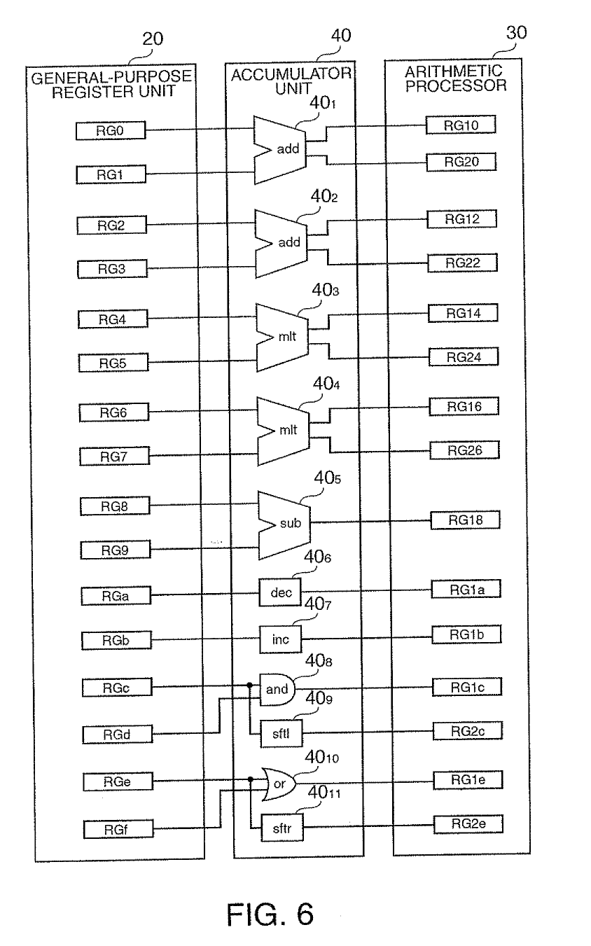

A block diagram of a detailed configuration example of the general-purpose register unit 20, the arithmetic processor 40, and the accumulator unit 30 according to this embodiment is shown in FIG. 6. In FIG. 6, components same as those shown in FIGS. 4 and 5 are denoted by the same reference numerals and signs and explanation of the components is omitted as appropriate.

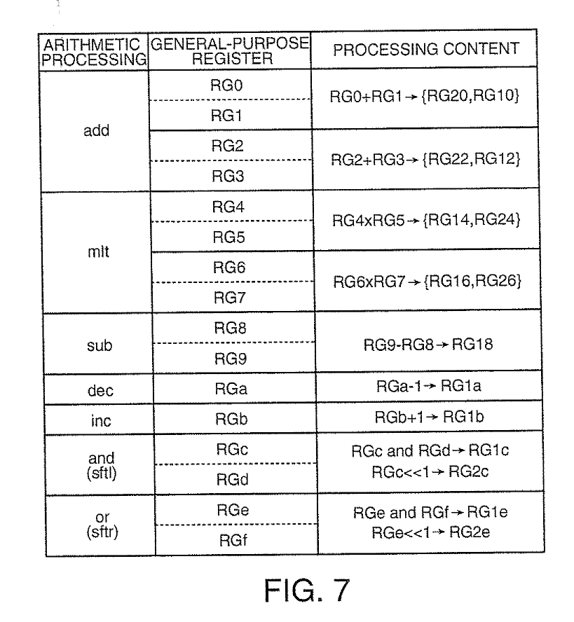

A diagram for explaining a processing example of the arithmetic processor 40 shown in FIG. 6 is shown in FIG. 7.

In FIG. 6, the arithmetic processor 40 includes plural arithmetic processing units 40₁ to 40₁₁. An example in which the arithmetic processor 40 includes eleven arithmetic processing units is explained with reference to FIG. 6. However, the invention is not limited by the number of arithmetic processing units. The arithmetic processor 40 only has to include plural arithmetic processing units.

The arithmetic processing unit 40₁ performs addition processing. The general-purpose registers RG0 and RG1 and the accumulators RG10 and RG20 are allocated to the arithmetic processing unit 40₁. In each of the execution cycles, the arithmetic processing unit 40₁ performs, in parallel to the arithmetic processing units 40₂ to 40₁₁, addition of input data of the general-purpose register RG0 and input data of the general-purpose register RG1 and stores a result of the addition in the accumulators RG10 and RG20. A lower-order bit side of the addition result is stored in the accumulator RG10 and a carry bit is stored in the accumulator RG20.

The arithmetic processing unit 40₂ also performs addition processing. However, general-purpose registers different from those for the arithmetic processing unit 40₁ are allocated to the arithmetic processing unit 40₂ as input registers. Specifically, the general-purpose registers RG2 and RG3 and the accumulators RG12 and RG22 are allocated to the arithmetic processing unit 40₂. In each of the execution cycles, the arithmetic processing unit 40₂ performs, in parallel to the arithmetic processing units 40₁ and 40₃ to 40₁₁, addition of input data of the general-purpose register RG2 and input data of the general-purpose register RG3 and stores a result of the addition in the accumulators RG12 and RG22. A lower-order bit side of the addition result is stored in the accumulator RG12 and a carry bit is stored in the accumulator RG22.

The arithmetic processing unit 40₃ performs multiplication processing. The general-purpose registers RG4 and RG5 and the accumulators RG14 and RG24 are allocated to the arithmetic processing unit 40₃. In each of the execution cycles, the arithmetic processing unit 40₃ performs, in parallel to the arithmetic processing units 40₁ to 40₂ and 40₄ to 40₁₁, multiplication of input data of the general-purpose register RG4 and input data of the general-purpose register RG5 and stores a result of the multiplication in the accumulators RG14 and RG24. A lower-order bit side of the multiplication result is stored in the accumulator RG14 and a higher-order bit side of the multiplication result is stored in the accumulator RG24.

The arithmetic processing unit 40₄ also performs multiplication processing. The general-purpose registers RG6 and RG7 and the accumulators RG16 and RG26 are allocated to the arithmetic processing unit 40₄. In each of the execution cycles, the arithmetic processing unit 40₄ performs, in parallel to the arithmetic processing units 40₁ to 40₃ and 40₅ to 40₁₁, multiplication of input data of the general-purpose register RG6 and input data of the general-purpose register RG7 and stores a result of the multiplication in the accumulators RG16 and RG26. A lower-order bit side of the multiplication result is stored in the accumulator RG16 and a higher-order bit side of the multiplication result is stored in the accumulator RG26.

The arithmetic processing unit 40₅ performs subtraction processing. The general-purpose registers RG8 and RG9 and the accumulator RG18 are allocated to the arithmetic processing unit 40₅. In each of the execution cycles, the arithmetic processing unit 40₅ performs, in parallel to the arithmetic processing units 40₁ to 40₄ and 40₆ to 40₁₁, subtraction for subtracting input data of the general-purpose register RG8 from input data of the general-purpose register RG9 and stores a result of the subtraction in the accumulator RG18.

The arithmetic processing unit 40₆ performs decrement operation processing. The general-purpose register RGa and the accumulator RG1a are allocated to the arithmetic processing unit 40₆. In each of the execution cycles, the arithmetic processing unit 40₆ performs, in parallel to the arithmetic processing units 40₁ to 40₅ and 40₇ to 40₁₁, decrement operation with 1 subtracted from input data of the general-purpose register RGa and stores a result of the decrement operation in the accumulator RG1a.

The arithmetic processing unit 40₇ performs increment operation processing. The general-purpose register RGb and the accumulator RG1b are allocated to the arithmetic processing unit 40₇. In each of the execution cycles, the arithmetic processing unit 40₇ performs, in parallel to the arithmetic processing units 40₁ to 40₆ and 40₈ to 40₁₁, increment operation with 1 added to input data of the general-purpose register RGb and stores a result of the increment operation in the accumulator RG1b.

The arithmetic processing unit 40₈ performs AND operation processing. The general-purpose registers RGc and RGd and the accumulator RG1c are allocated to the arithmetic processing unit 40₈. In each of the execution cycles, the arithmetic processing unit 40₈ performs, in parallel to the arithmetic processing units 40₁ to 40₇ and 40₉ to 40₁₁, AND operation of input data of the general-purpose register RGc and input data of the general-purpose register RGd and stores a result of the AND operation in the accumulator RG1c.

The arithmetic processing unit 40₉ performs logical shift operation in the left direction. The general-purpose register RGc and the accumulator RG2c are allocated to the arithmetic processing unit 40₉. In each of the execution cycles, the arithmetic processing unit 40₉ performs, in parallel to the arithmetic processing units 40₁ to 40₉, 40₁₀, and 40₁₁, shift operation with input data of the general-purpose register RGc shifted in the left direction and stores a result of the shift operation in the accumulator RG2c.

The arithmetic processing unit 40₁₀ performs OR operation processing. The general-purpose registers RGe and RGf and the accumulator RG1e are allocated to the arithmetic processing unit 40₁₀. In each of the execution cycles, the arithmetic processing unit 40₁₀ performs, in parallel to the arithmetic processing units 40₁ to 40₉ and 40₁₁, OR operation of input data of the general-purpose register RGe and input data of the general-purpose register RGf and stores a result of the OR operation in the accumulator RG1e.

The arithmetic processing unit 40₁₁ performs logical shift operation processing in the right direction. The general-purpose register RGe and the accumulator RG2e are allocated to the arithmetic processing unit 40₁₁. In each of the execution cycles, the arithmetic processing unit 40₁₁ performs, in parallel to the arithmetic processing units 40₁ to 40₁₀, shift operation with input data of the general-purpose register RGe shifted in the right direction and stores a result of the shift operation in the accumulator RG2e.

The arithmetic processing units 40₁ to 40₁₁ of the arithmetic processor 40 shown in FIG. 6 respectively update values of the accumulators corresponding thereto in each of the execution cycles. Specifically, irrespectively of a decoding result of the instruction decoding unit 60, the arithmetic processing units 40₁ to 40₁₁ respectively perform arithmetic processing in each of the execution cycles. Therefore, before the execution cycles, when input data of the general-purpose registers allocated thereto are rewritten, data stored in the accumulators corresponding thereto change.

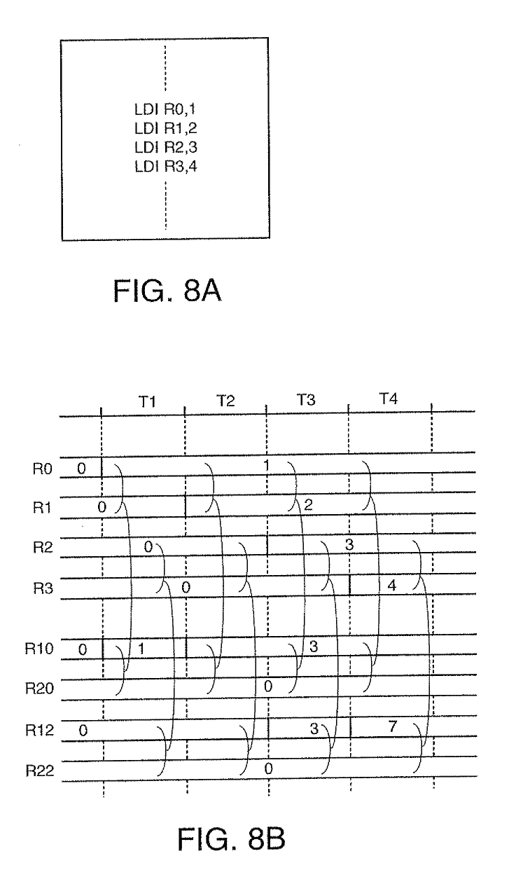

Diagrams for explaining an operation example of the CPU 100 shown in FIG. 2 are shown in FIGS. 8A and 8B. FIG. 8A is a diagram of an example of a computer program of the CPU 100. In FIG. 8A, an instruction LDI is a transfer instruction for transferring a designated immediate value to a general-purpose register. FIG. 8B is a timing chart of the operation example of the CPU 100. States of the general-purpose registers and the accumulators are schematically shown in FIG. 8B with a delay due to arithmetic operation neglected.

For example, as shown in FIG. 8A, immediate values “1”, “2”, “3”, and “4” are respectively transferred to the general-purpose registers R0, R1, R2, and R3. A processing example of the arithmetic processing units 40₁ and 40₂ in this case is examined. It is assumed that, immediately before this data transfer instruction sequence, the general-purpose registers R0, R1, R2, and R3 and the accumulators RG10, RG20, RG12, and RG22 are initialized and data of the general-purpose registers and the accumulators are “0”.

First, in an execution cycle T1, the immediate value “1” is set in the general-purpose register R0. According to the setting, in the execution cycle T1, the arithmetic processing unit 40₁ sets, in the accumulator RG10, an addition result “1” obtained by adding up “1” set in the general-purpose register R0 and “0” set in the general-purpose register R1. At this point, since a carry bit is “0”, data of the accumulator RG20 is kept. Similarly, the arithmetic processing unit 40₂ sets, in the accumulator RG12, an addition result “0” obtained by adding up “0” set in the general-purpose register R2 and “0” set in the general-purpose register R3. However, data of the accumulator RG12 is kept. At this point, since a carry bit is “0”, data of the accumulator RG22 is kept.

Subsequently, in an execution cycle T2, the immediate value “2” is set in the general-purpose register R1. According to the setting, in the execution cycle T2, the arithmetic processing unit 40₁ sets, in the accumulator RG10, an addition result “3” obtained by adding up “1” set in the general-purpose register R0 and “2” set in the general-purpose register R1. At this point, since a carry bit is “0”, the data of the accumulator RG20 is kept. On the other hand, since data of the general-purpose registers R2 and R3 are kept, the arithmetic processing unit 40₂ sets the addition result in the accumulator RG12. However, the data of the accumulator RG12 is kept. At this point, since a carry bit is “0”, the data of the accumulator RG22 is kept.

In an execution cycle T3, the immediate value “3” is set in the general-purpose register R2. According to the setting, in the execution cycle T3, since data of the general-purpose registers R0 and R1 are kept, the arithmetic processing unit 40₁ keeps the data of the accumulators RG10 and RG20. On the other hand, the arithmetic processing unit 40₂ sets, in the accumulator RG12, an addition result “3” obtained by adding up “3” set in the general-purpose register R2 and “0” set in the general-purpose register R3. At this point, since a carry bit is “0”, the data of the accumulator RG22 is kept.

In an execution cycle T4, the immediate value “4” is set in the general-purpose register R3. According to the setting, since the data of the general-purpose registers R0 and R1 are kept, the arithmetic processing unit 40₁ keeps the data of the accumulators RG10 and RG20. On the other hand, the arithmetic processing unit 40₂ sets, in the accumulator RG12, an addition result “7” obtained by adding up “3” set in the general-purpose register R2 and “4” set in the general-purpose register R3. At this point, since a carry bit is “0”, the data of the accumulator R22 is kept.

In this way, even if an addition instruction is not included in an instruction sequence of a computer program, it is possible to obtain an addition result in each of the execution cycles simply by setting data in the general-purpose registers allocated to the input registers. Specifically, the CPU 100 does not need to have, in an operation code, an arithmetic operation instruction, a logical operation instruction, and a shift operation instruction corresponding to the arithmetic processing performed by the arithmetic processing units 40₁ to 40₁₁ of the arithmetic processor 40. It is possible to allocate a small bit field to other instructions and improve code efficiency to be extremely high.

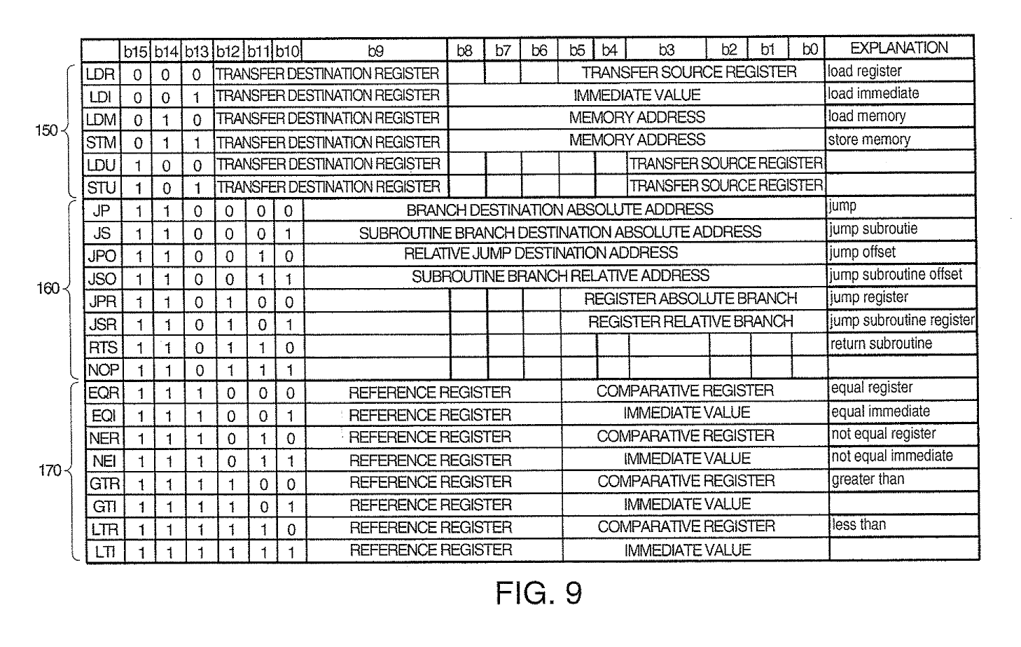

A diagram for explaining an example of an instruction set of the CPU 100 according to this embodiment is shown in FIG. 9. In FIG. 9, explanation of a 16-bit operation code and processing content is shown for each of mnemonics.

The instruction set of the CPU 100 is shown in FIG. 9. All instructions executable by the CPU 100 are listed in FIG. 9. Specifically, the instruction set of the CPU 100 includes a data transfer instruction group 150 and conditional branch instruction groups (more specifically, an unconditional branch instruction group 160 and a conditional branch instruction group 170). The arithmetic operation instruction, the logical operation instruction, and the shift operation instruction performed by the arithmetic processor 40 are omitted.

The data transfer instruction group 150 includes an inter-register transfer instruction and an inter-register-memory transfer instruction.

The inter-register transfer instruction includes an LDR instruction. The LDR instruction is an instruction for instructing transfer from a transfer source register designated as a transfer source by an operation code section to a transfer destination register designated as a transfer destination by the operation code section. The inter-register-memory transfer instruction includes an LDI instruction, an LDM instruction, an STM instruction, an LDU instruction, and an STU instruction. The LDI instruction is an instruction for instructing transfer of an immediate value designated by an operation code section to transfer destination register designated by the operation code section. The LDM instruction is an instruction for instructing transfer of data stored in an address on a memory at a transfer source designated by an operation code section to a transfer destination register designated by the operation code section. The STM instruction is an instruction for instructing transfer of data set in a transfer source register designated by an operation code section to an address on a memory at a transfer destination designated by the operation code section. The LDU instruction is an instruction for instructing readout of a value as an address of a transfer source register designated by an operation code section and transfer of the value to a transfer destination register designated by the operation code section. The STU instruction is an instruction for instructing transfer of data set in a transfer source register designated by an operation code section to a storage area of a memory having a value of a transfer destination register as an address.

The unconditional branch instruction group 160 includes a JP instruction, a JS instruction, a JPO instruction, a JSO instruction, a JPR instruction, a JSR instruction, an RTS instruction, and an NOP instruction. The JP instruction is an instruction for instructing branching to a branch destination absolute address designated by an operation code section. The JS instruction is a subroutine branch instruction and is an instruction for subroutine branch to a subroutine branch destination absolute address designated by an operation code section. The JPO instruction is an instruction for instructing branching to a branch destination address advanced by a relative jump destination address designated by an operation code section or a branch destination address returned by the relative jump destination address with reference to, for example, a present execution address. The JPR instruction is an instruction for instructing branching with a value stored in a register designated by an operation code section set as a branch destination address. The JSR instruction is an instruction for instructing, with a value stored in a register designated by an operation code section set as an absolute value, branching to a branch destination address advanced by the absolute value or a branch destination address returned by the absolute value with reference to, for example, a present execution address. The RTS instruction is a subroutine return instruction. The NOP instruction is an instruction for instructing execution of no instruction.

The conditional branch instruction group 170 includes an EQR instruction, an EQI instruction, an NER instruction, an NEI instruction, a GTR instruction, a GTI instruction, an LTR instruction, and an LTI instruction.

The EQR instruction is an instruction for instructing branching to, for example, a branch destination address designated by an operand section when a value stored in a reference register designated by an operation code section and a value stored in a comparative register designated by the operation code section coincide with each other. The EQI instruction is an instruction for instructing branching to, for example, a branch destination address designated by an operand section when a value stored in a reference register designated by an operation code section and an immediate value designated by the operation code section coincide with each other.

The NER instruction is an instruction for instructing branching to, for example, a branch destination address designated by an operand section when a value stored in a reference register designated by an operation code section and a value stored in a comparative register designated by the operation code section coincide with each other. The NEI instruction is an instruction for instructing branching to, for example, a branch destination address designated by an operand section when a value stored in a reference register designated by an operation code section and an immediate value designated by the operation code section do not coincide with each other.

The GTR instruction is an instruction for instructing branching to, for example, a branch destination address designated by an operand section when a value stored in a reference register designated by an operation code section is larger than a value stored in a comparative register designated by the operation code section. The GTI instruction is an instruction for instructing branching to, for example, a branch destination address designated by an operand section when a value stored in a reference register designated by an operation code section is larger than an immediate value designated by the operation code section.

The LTR instruction is an instruction for instructing branching to, for example, a branch destination address designated by an operand section when a value stored in a reference register designated by an operation code section is smaller than a value stored in a comparative register designated by the operation code section. The LTI instruction is an instruction for designating branching to, for example, a branch destination address designated by an operand section when a value stored in a reference register designated by an operation code section is smaller than an immediate value designated by the operation code section.

In this way, in this embodiment, only the data transfer instruction group 150, the unconditional branch instruction group 160, and the conditional branch instruction group 170 are specified in the instruction set of the CPU 100. However, since the arithmetic processor 40 is provided, it is possible to obtain an arithmetic operation result, a logical operation result, and a shift operation result in each of the give execution cycles. Specifically, the instruction decoding unit 60 of the CPU 100 decodes a data transfer instruction and branch instructions (an unconditional branch instruction and a conditional branch instruction) excluding an arithmetic operation instruction, a logical operation instruction, and a shift operation instruction. Moreover, irrespectively of a decoding result of the instruction decoding unit 60, the plural arithmetic processing units of the arithmetic processor 40 store, in each of the execution cycles, processing results of the arithmetic processing units in the accumulators corresponding thereto. Consequently, the instruction decoding unit 60 is simplified and does not need to have an arithmetic operation instruction, a logical operation instruction, and a shift operation instruction in an operation code. Therefore, it is possible to allocate a small bit field to other instructions and improve code efficiency to be extremely high.

Further, since it is unnecessary to have the arithmetic operation instruction, the logical operation instruction, and the shift operation instruction in the operation code, a code of a computer program executed by the CPU 100 can realize effects explained below compared with codes in the past.

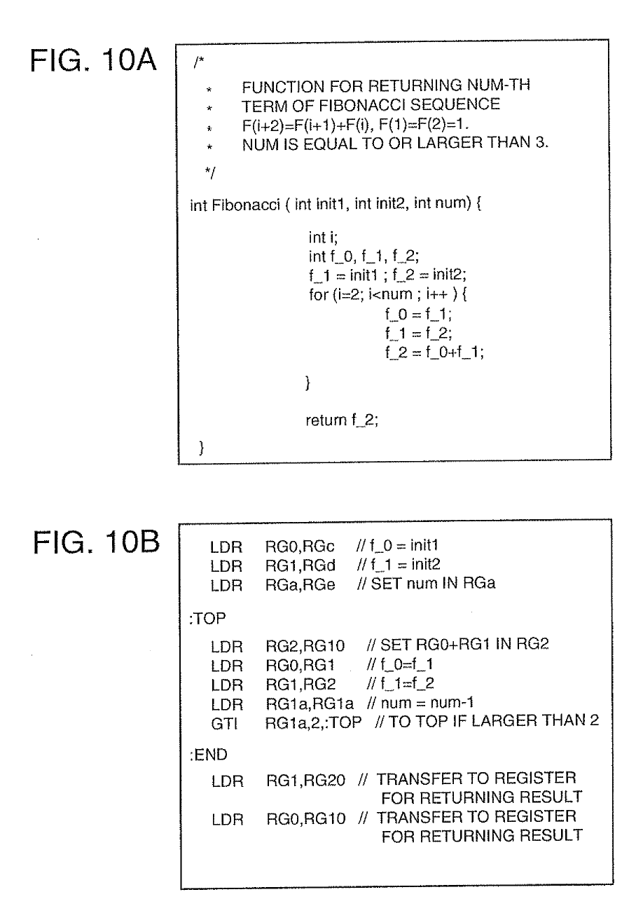

Diagrams for explaining effects of the code of the computer program executed by the CPU 100 according to this embodiment are shown in FIGS. 10A and 10B. FIG. 10A is a diagram of a code example in which a function for returning a num-th (num≧3) of the Fibonacci sequence is represented by the C language. FIG. 10B is a diagram of an example in which the code shown in FIG. 10A is represented by the assembler using the mnemonic shown in FIG. 9.

As shown in FIG. 10A, in this function, decrement operation of an integer-type variable i and addition of integer-type variables f_0 and f_1 are repeatedly performed. On the other hand, when the function is converted into the assembler corresponding to the instruction set of the CPU 100 according to this embodiment, as shown in FIG. 10B, the code is an instruction sequence including a data transfer instruction and a conditional branch instruction.

Specifically, in FIG. 10B, an addition instruction and a decrement operation instruction are not included. An addition result is acquired by simply setting values in the general-purpose registers RG0 and RG1 corresponding to the arithmetic processing unit 40₁ shown in FIG. 6 and a decrement operation result is acquired by simply setting a value in the general-purpose register RGa corresponding to the arithmetic processing unit 40₆ shown in FIG. 6 according to the data transfer instruction. Moreover, in the instruction sequence, the general-purpose register RG2 is used for saving a value of a variable. In FIG. 10B, if a return value is a short type, the return value is transferred to the general-purpose register RG0 and, if a return value is an int type, the return value is transferred to the general-purpose registers RG0 and RG1.

Specifically, as shown in FIG. 10B, an arithmetic operation result can be acquired after a given execution cycle simply by setting a value in a general-purpose register. On the other hand, if the arithmetic operation result that can be acquired after the given execution cycle is not used, the general-purpose register can be used as a register in the past.

In this way, according to this embodiment, the arithmetic operation processing and the like can be realized by the instruction data sequence not including an arithmetic operation instruction, a logical operation instruction, and a shift operation instruction. Therefore, code efficiency can be improved to be extremely high as explained above. Further, according to this embodiment, as shown in FIG. 10B, it is possible to increase difficulty in reading a code and make disassemble difficult to generate a code with high security. As a result, it is possible to contribute to reverse engineering prevention and improvement of security.

In this embodiment, as shown in FIG. 6, the arithmetic processing units included in the plural arithmetic processing units of the arithmetic processor 40 are explained as respectively performing the arithmetic processing determined in advance such as addition and subtraction. However, the invention is not limited to this.

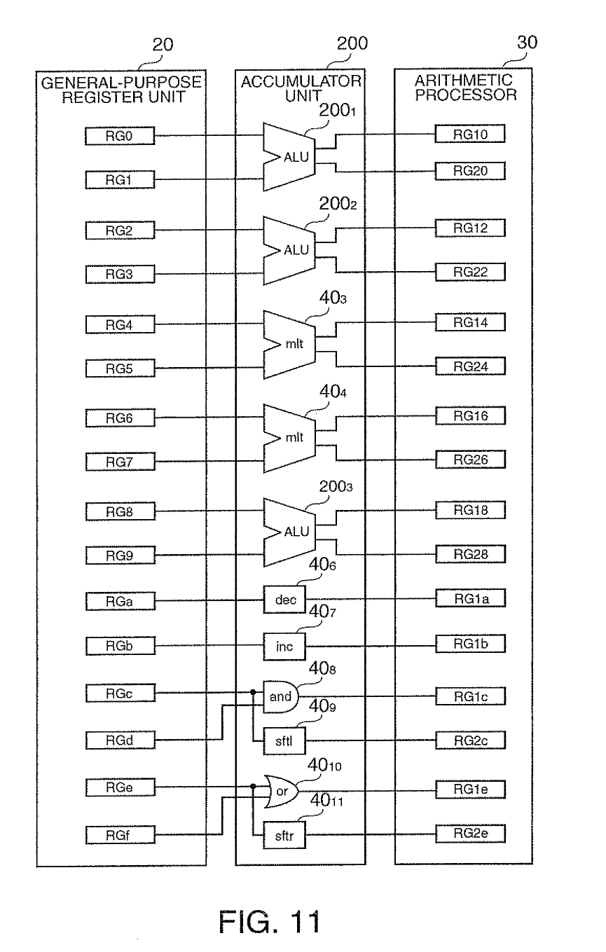

A block diagram of a configuration example of an arithmetic processor according to a modification of this embodiment is shown in FIG. 11. In FIG. 11, components same as those shown in FIG. 6 are denoted by the same reference numerals and signs and explanation of the components is omitted as appropriate.

An arithmetic processor 200 according to this modification is included in the CPU 100 instead of the arithmetic processor 40 shown in FIG. 2. The arithmetic processor 200 includes plural arithmetic processing units 200₁ to 200₃, 40₃ and 40₄, and 40₆ to 40₁₁. The arithmetic processing units 200₁ to 200₃ are arithmetic logical operation units having the same configuration as one another. In FIG. 11, an example in which the arithmetic processor 200 includes eleven arithmetic processing units is explained. However, the invention is not limited by the number of arithmetic processing units. The arithmetic processor 200 only has to have plural arithmetic processing units.

The arithmetic processing units included in the arithmetic processing units 200₁ to 200₃ perform any one kind of arithmetic processing of addition processing and subtraction processing. The arithmetic processing units are designated to perform any one kind of arithmetic processing of the addition processing and the subtraction processing according to, for example, control data of a not-shown control register.

The general-purpose registers RG0 and RG1 and the accumulators RG10 and RG20 are allocated to the arithmetic processing unit 200₁. In each of the execution cycles, the arithmetic processing unit 200₁ performs, in parallel to the arithmetic processing units 200₂, 40₃ and 40₄, 200₃, and 40₆ to 40₁₁, arithmetic operation designated by the control data using input data of the general-purpose register RG0 and input data of the general-purpose register RG1 and stores a result of the arithmetic operation in the accumulators RG10 and RG20. A lower-order bit side of the arithmetic operation result is stored in the accumulator RG10 and a higher-order side of the arithmetic operation result is stored in the accumulator RG20.

The arithmetic processing unit 200₂ also performs arithmetic operation designated by the control data. However, general-purpose registers different from allocated to the arithmetic processing unit 200₂ as input registers. Specifically, the general-purpose registers RG2 and RG3 and the accumulators RG12 and RG22 are allocated to the arithmetic processing unit 200₂. In each of the execution cycles, the arithmetic processing unit 200₂ performs, in parallel to the arithmetic processing units 200₁, 40₃ and 40₄, 200₃, and 40₆ to 40₁₁, the arithmetic operation designated by the control data using input data of the general-purpose register RG2 and input data of the general-purpose register RG3 and stores a result of the arithmetic operation in the accumulators RG12 and RG22. A lower-order bit side of the arithmetic operation result is stored in the accumulator RG12 and a higher-order bit side of the arithmetic operation result is stored in the accumulator RG22.

The arithmetic processing unit 200₃ also performs arithmetic operation designated by the control data. However, general-purpose registers different from those for the arithmetic processing units 200₁ and 200₂ are allocated to the arithmetic processing unit 200₃ as input registers. Specifically, the general-purpose registers RG8 and RG9 and the accumulators RG18 and RG28 are allocated to the arithmetic processing unit 200₃. In each of the execution cycles, the arithmetic processing unit 200₃ performs, in parallel to the arithmetic processing units 200₁ and 200₂, 40₃ and 40₄, and 40₆ to 40₁₁, the arithmetic operation designated by the control data using input data of the general-purpose register RG8 and input data of the general-purpose register RG9 and stores a result of the arithmetic operation in the accumulators RG18 and RG28. A lower-order bit side of the arithmetic operation result is stored in the accumulator RG18 and a higher-order bit side of the arithmetic operation result is stored in the accumulator RG28.

The arithmetic processing units 200₁ to 200₃, 40₃ and 40₄, and 40₆ to 40₁₁ of the arithmetic processing unit 200 shown in FIG. 11 respectively update values of the accumulators corresponding thereto in each of the execution cycles. Specifically, irrespectively of a decoding result of the instruction decoding unit 60, the arithmetic processing units 200₁ to 200₃, 40₃ and 40₄, and 40₆ to 40₁₁ respectively perform arithmetic processing in each of the execution cycles. Therefore, when input data of the general-purpose registers allocated thereto are written before the execution cycle, data stored in the corresponding accumulators change.

According to this modification, it is possible to dynamically switch arithmetic processing, which are operable in parallel, according to arithmetic processing content and obtain higher arithmetic operation ability at extremely high code efficiency.

In FIG. 11, at least one of the arithmetic processing units 40₆ to 40₈ and 40₁₀ may have a configuration same as that of the arithmetic processing unit 200₁ and perform arithmetic operation according to control data set in the not-shown control register.

### 2. Electronic Apparatus

The CPU according to this embodiment or the modification thereof can be mounted on an electronic apparatus such as a projector. An example in which the electronic apparatus according to this embodiment or the modification thereof is a projector is explained below. However, the electronic apparatus to which the CPU according to this embodiment or the modification thereof is not limited to the projector. It goes without saying that the CPU can be applied to various electronic apparatuses.

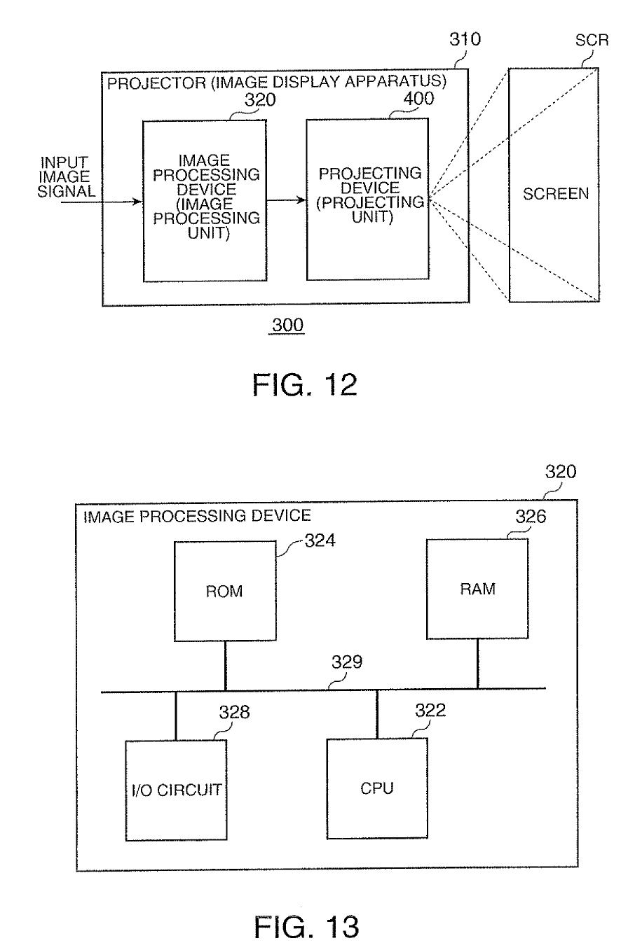

A block diagram of a configuration example of an image display system including the projector as the electronic apparatus according to this embodiment is shown in FIG. 12.

An image display system 300 includes a projector (in a broad sense, an image display apparatus) 310 and a screen SCR. The projector 310 modulates light from a not-shown light source on the basis of an input image signal and projects the light after the modulation on the screen SCR to display an image.

The projector 310 includes an image processing device 320 (in a broad sense, an image processing unit) and a projecting device 400 (in a broad sense, projecting unit and an image display unit). The image processing device 320 corrects the input image signal and outputs the image signal after the correction to the projecting device 400. Examples of correction processing performed by such an image processing device 320 include edge enhancement processing, detail enhancement processing, and gradation correction processing. The projecting device 400 projects light modulated on the basis of the image signal from the image processing device 320 on the screen SCR.

A block diagram of a hardware configuration example of the image processing device 320 shown in FIG. 12 is shown in FIG. 13.

The image processing device 320 includes a CPU 322, a read only memory (ROM) 324, a random access memory (RAM) 326, an I/O (Input/Output) circuit 328, and a bus 329. The CPU 322, the ROM 324, the RAM 326, and the I/O circuit 328 are electrically connected to one another via the bus 329.

For example, a computer program and data for realizing functions of the image processing device 320 are stored in the ROM 324 or the RAM 326. The computer program is an instruction data sequence including an operation code section and an operand section corresponding to the operation code specified by the instruction set shown in FIG. 9. The data stored in the ROM 324 or the RAM 326 is referred to by instruction data forming the instruction data sequence.

The CPU 322 has the configuration and the functions of the CPU 100 shown in FIG. 2 as the information processing device 10 according to this embodiment or the modification thereof. The CPU 322 can realize the functions of the image processing device 324 in software processing by reading out the computer program stored in the ROM 324 or the RAM 326 and executing processing corresponding to the computer program. The RAM 326 is used as a work area for processing by the CPU 322 and used as a buffer area for the I/O circuit 328 and the ROM 324.

The I/O circuit 328 performs input interface processing for an image signal from a not-shown image signal generating device, output interface processing for an image signal from the image processing device 300 to the projecting device 400, and the like.

With the configuration shown in FIG. 13, the image processing device 320 reads out the computer program stored in the ROM 324 and the RAM 326 and executes processing corresponding to the computer program to generate, in software processing, an image signal obtained by applying, for example, edge enhancement processing, detail enhancement processing, or gradation correction processing to an input image signal. In this embodiment, the arithmetic operation processing and the like can be realized by the instruction data sequence not including an arithmetic operation instruction, a logical operation instruction, and a shift operation instruction. Therefore, it is possible to perform image processing such as the edge enhancement processing, the detail enhancement processing, and the gradation correction processing at extremely high code efficiency and with increased difficulty in reading a code and a code with high security. The image signal processed by such an image processing device 320 is sent to the projecting device 400.

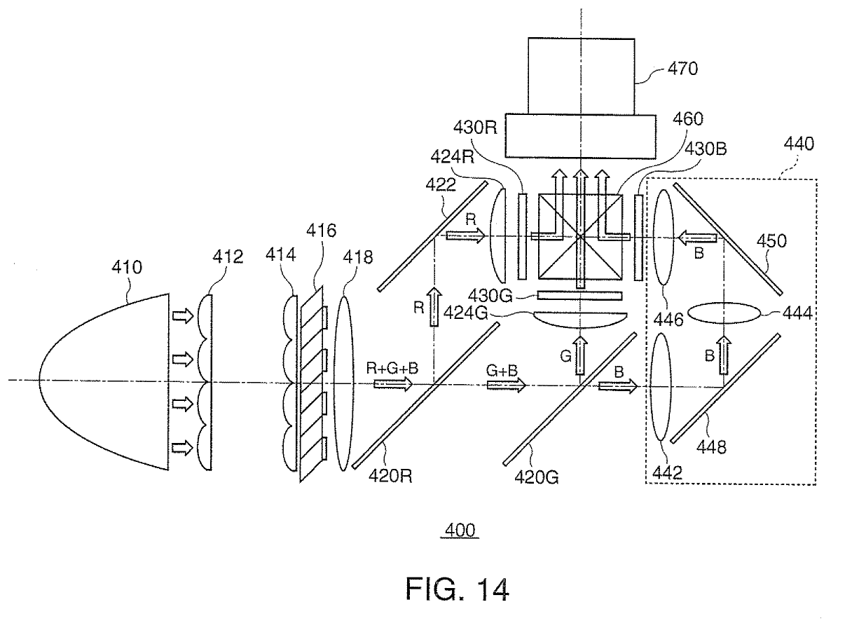

A diagram of a configuration example of the projecting device 400 shown in FIG. 1 is shown in FIG. 14. In FIG. 14, the projecting device 400 is explained as including a so-called 3LCD liquid crystal projector. However, the projecting device according to the invention is not limited to the projecting device including the 3LCD liquid crystal projector. In the following explanation, one pixel is explained as including a sub-pixel for an R component, a sub-pixel for a G component, and a sub-pixel for a B component. However, the invention is not limited by the number of sub-pixels (the number of color components) included in one pixel.

In FIG. 14, it is assumed that, after a luminance signal Y and color difference signals U and V input from the image processing device 320 are converted into image signals of respective color components R, G, and B, light from a light source is modulated for each of the color components. In this case, a converting circuit for conversion into the R, G, and B signals may be included in the image processing device 320 or may be included in the projecting device 400.

The projecting device 400 includes a light source 410, integrator lenses 412 and 414, a deflection converting element 416, a superimposing lens 418, a dichroic mirror for R 420R, a dichroic mirror for G 420G, a reflection mirror 422, a field lens for R 424R, a field lens for G 424G, a liquid crystal panel for R 430R (a first light modulating element), a liquid crystal panel for G 430G (a second light modulating element), a liquid crystal panel for B 430B (a third light modulating element), a relay optical system 440, a cross dichroic prism 460, and a projection lens 470. Liquid crystal panels used as the liquid crystal panel for R 430R, the liquid crystal panel for G 430G, and the liquid crystal panel for B 430B are transmissive liquid crystal display devices. The relay optical system 440 includes relay lenses 442, 444, and 446 and reflection mirrors 448 and 450.

The light source 410 includes, for example, an ultrahigh pressure mercury lamp and emits light including at least light of an R component, light of a G component, and light of a B component. The integration lens 412 includes plural small lenses for dividing light from a light source device 410 into plural partial lights. The integrator lens 414 has plural small lenses corresponding to the plural small lenses of the integrator lens 412. The superimposing lens 418 superimposes, on a liquid crystal panel, the partial lights emitted from the plural small lenses of the integrator lens 412.

The polarization converting element 416 includes a polarization beam splitter array and a λ/2 plate and converts light from the light source 410 into a generally one kind of polarized light. The polarization beam splitter array has structure in which a polarization separating film that separates the partial lights, which are divided by the integrator lens 412, into p-polarized light and s-polarized light and a reflection film that changes a direction of light from the polarization separating film are alternately arrayed. Two kinds of polarized light separated by the polarization separating film are aligned in a polarization direction by the λ/2 plate. The light converted into the generally one kind of polarized light by the polarization converting element 416 is irradiated on the superimposing lens 418.

The light from the superimposing lens 418 is made incident on the dichroic mirror for R 420R. The dichroic mirror for R 420R has a function of reflecting the light of the R component and transmitting lights of the G component and the B component. The light transmitted through the dichroic mirror for R 420R is irradiated on the dichroic mirror for G 420G. The light reflected by the dichroic mirror for R 420R is reflected by the reflection mirror 422 and guided to the field lens for R 424R.

The dichroic mirror for G 420G has a function of reflecting the light of the G component and transmitting the light of the B component. The light transmitted through the dichroic mirror for G 420G is made incident on the relay optical system 440. The light reflected by the dichroic mirror for G 420G is guided to the field lens for G 424G.

In order to reduce a difference between optical path length of the light of the B component transmitted through the dichroic mirror for G 420G and optical path length of the other lights of the R component and the G component as much as possible, the relay optical system 440 corrects the difference between the optical path lengths using the relay lenses 442, 444, and 446. The light transmitted through the relay lens 442 is guided to the relay lens 444 by the reflection mirror 448. The light transmitted through the relay lens 444 is guided to the relay lens 446 by the reflection mirror 450. The light transmitted through the relay lens 446 is irradiated on the liquid crystal panel for B 430B.

The light irradiated on the field lens for R 424R is converted into parallel rays and made incident on the liquid crystal panel for R 430R. The liquid crystal panel for R 430R functions as a light modulating element (a light modulating unit). The transmittance (passing rate or modulation rate) thereof changes on the basis of an image signal for R. Therefore, the light (light of a first color component) made incident on the liquid crystal panel for R 430R is modulated on the basis of the image signal for R. The light after the modulation is made incident on the cross dichroic prism 460.

The light irradiated on the field lens for G 424G is converted into parallel rays and made incident on the liquid crystal panel for G 430G. The liquid crystal panel for G 430G functions as a light modulating element (a light modulating unit). The transmittance (passing rate or modulation rate) thereof changes on the basis of an image signal for G. Therefore, the light (light of a second color component) made incident on the liquid crystal panel for G 430G is modulated on the basis of the image signal for G. The light after the modulation is made incident on the cross dichroic prism 460.

The liquid crystal panel for B 430B on which the lights converted into parallel rays by the relay lenses 442, 444, and 446 are irradiated functions as a light modulating element (a light modulating unit). The transmittance (passing rate or modulation rate) thereof changes on the basis of an image signal for B. Therefore, the light (light of a third color component) made incident on the liquid crystal panel for B 430B is modulated on the basis of the image signal for B. The light after the modulation is made incident on the cross dichroic prism 460.

The liquid crystal panel for R 430R, the liquid crystal panel for G 430G, and the liquid crystal panel for B 430B have the same configuration as one another. The liquid crystal panels are formed by filling and enclosing liquid crystal as an electro-optic substance in a pair of transparent glass substrates. The liquid crystal panels modulate passing rates of the color lights according to image signals of the sub-pixels using, for example, a polysilicon thin-film transistor as a switching element.

In this embodiment, the image processing device 320 generates, for each of the color components forming one pixel, an image signal obtained by applying, for example, the edge enhancement processing, the detail enhancement processing, and the gradation correction processing to an input image signal. In the projecting device 400, liquid crystal panels as light modulating elements are provided for the respective color components forming one pixel. The transmittances of the liquid crystal panels are controlled by the image signals corresponding to the sub-pixels. Specifically, the image signal for the sub-pixel for the R component is used for controlling the transmittance (passing rate or modulation rate) of the liquid crystal panel for R 430R. The image signal for the sub-pixel for the G component is used for controlling the transmittance of the liquid crystal panel 430G. The image signal for the sub-pixel for the B component is used for controlling the transmittance of the liquid crystal panel for B 430B.

The cross dichroic prism 460 has a function of outputting, as emission light, combined light obtained by combining the incident lights from the liquid crystal panel for R 430R, the liquid crystal panel for G 430G, and the liquid crystal panel for B 430B. The projection lens 470 is a lens that focuses an output image on the screen SCR in enlargement.

The image display system 300 according to this embodiment can control the projecting device 400 having such a configuration and display an image on the screen SCR on the basis of the image signal corrected in the gradation correction processing or the like.

As explained above, the projector 310 includes the memory that stores a computer program and data and the CPU 322 (or the image processing device 320 including the CPU 322) that performs arithmetic processing corresponding to the computer program and the data. According to this embodiment, it is possible to provide the projector 310 or the image display system 300 including the projector 310 that can realize complicated arithmetic processing at extremely high code efficiency and, on the other hand, can perform reverse engineering prevention and improvement of security.

The information processing device, the arithmetic processing method, the electronic apparatus, and the like have been explained on the basis of the embodiment or the modification thereof. However, the invention is not limited to the embodiment or the modification thereof. The invention can be carried out in various forms without departing from the spirit of the invention. For example, modifications explained below are also possible.

(1) In the embodiment or the modification thereof, the general-purpose register is allocated in advance to any one of the arithmetic processing units included in the arithmetic processor. However, the general-purpose registers may be dynamically allocated to any one of the plural arithmetic processing units included in the arithmetic processor.

(2) In the embodiment or the modification thereof, the accumulator is allocated in advance to any one of the arithmetic processing units included in the arithmetic processor. However, the accumulators may be dynamically allocated to any one of the plural arithmetic processing units included in the arithmetic processor,

(3) The invention is not limited by the number of general-purpose registers and the number of accumulators explained in the embodiment or the modification.

(4) In the embodiment or the modification thereof, the arithmetic operation, the logical operation, and the shift operation shown in FIG. 7 are explained as examples of the arithmetic operation performed by the arithmetic processing units. However, the invention is not limited to the arithmetic operation, the logical operation, and the shift operation shown in FIG. 7. For example, the arithmetic processing units may perform division.

(5) In the embodiment or the modification, the instruction set shown in FIG. 9 is explained as an example. However, the invention is not limited to the instruction set shown in FIG. 9.

(6) In the embodiment or the modification thereof, the projector is explained as an example of the electronic apparatus to which the information processing device according to the invention is applied. However, the invention is not limited to this. In the projector, one pixel is explained as including the sub-pixels for the three color components. However, the invention is not limited to this. The number of color components included in one pixel may be two or four or more. The transmissive liquid crystal panel is explained as being used as the light modulation element of the projector. However, the invention is not limited to this. For example, DLP (Digital Light Processing) (registered trademark) or LCOS (Liquid Crystal On Silicon) may be adopted as the light modulating unit. Further, the light valve employing a so-called 3LCD transmissive liquid crystal panel is explained as an example of the light modulation element of the projector. However, a light valve employing, for example, a 1LCD liquid crystal panel or a 4LCD or higher transmissive liquid crystal panel may be adopted.

(7) In the embodiment or the modification, the invention is explained as the information processing device, the arithmetic processing method, and the electronic apparatus. However, the invention is not limited to this.

What is claimed is:

1. An information processing device comprising:
a first arithmetic processing unit performing first arithmetic processing;
a second arithmetic processing unit performing second arithmetic processing;
input registers adapted to include a first input register allocated to the first arithmetic processing unit, and a second input register allocated to the second arithmetic processing unit; and
output registers storing a processing results of the first arithmetic processing unit and a processing results of the second arithmetic processing unit,
in each of given execution cycles, the first arithmetic processing unit performs the first arithmetic processing using stored data of the first input register and stores a processing result of the first arithmetic processing in the output registers and the second arithmetic processing unit performs the second arithmetic processing using stored data of the second input register and stores a processing result of the second arithmetic processing in the output registers.

2. The information processing device according to claim 1, wherein the output registers include:
a first output register allocated to the first arithmetic processing unit; and
a second output register allocated to the second arithmetic processing unit,
the first arithmetic processing unit stores a processing result of the first arithmetic processing in the first output register and the second arithmetic processing unit stores a processing result of the second arithmetic processing in the second output register.

3. The information processing device according to claim 1, further comprising an instruction decoding unit that decodes fetched instruction data, wherein
irrespectively of a decoding result of the instruction decoding unit, in each of the execution cycles, the first arithmetic processing unit and the second arithmetic processing unit store arithmetic operation results of the arithmetic processing units in the output registers corresponding thereto.

4. The information processing device according to claim 3, wherein the instruction decoding unit decodes a data transfer instruction and a branch instruction excluding an arithmetic operation instruction, a logical operation instruction, and a shift operation instruction.

5. The information processing device according to claim 2, wherein the stored data of the first output register or the stored data of the second output register is formed to be transferable to any one of the input registers.

6. The information processing device according to claim 2, wherein
the first input register is allocated to the second arithmetic processing unit, and
the second arithmetic processing unit performs, in each of the execution cycles, the second arithmetic processing using the stored data of the first input register and stores a processing result of the second arithmetic processing in the second output register.

7. The information processing device according to claim 1, wherein the first arithmetic processing unit or the second arithmetic processing unit performs any one kind of arithmetic processing among addition, multiplication, subtraction, logical operation, and shift operation.

8. The information processing device according to claim 1, wherein the first arithmetic processing unit and the second arithmetic processing unit are arithmetic logical operation units having a same configuration.

9. The information processing device according to claim 1, wherein the input registers are general-purpose registers.

10. The information processing device according to claim 1, wherein the output registers are accumulators.

11. The information processing device according to claim 1, wherein the first arithmetic processing unit and the second arithmetic processing unit are configured to be operable in parallel to each other.

12. An arithmetic processing method for an information processing device including: a first arithmetic processing unit that performs first arithmetic processing; a second arithmetic processing unit that performs second arithmetic processing; input registers including a first input register and a second input register; and output registers in which a processing result of the first arithmetic processing unit and a processing result of the second arithmetic processing unit are stored, the arithmetic processing method comprising:
allocating the first input register to the first arithmetic processing unit; and
allocating the second input register to the second arithmetic processing unit,
in each of given execution cycles, the first arithmetic processing unit performing the first arithmetic processing using stored data of the first input register and storing a processing result of the first arithmetic processing in the output registers and the second arithmetic processing unit performing the second arithmetic processing using stored data of the second input register and storing a processing result of the second arithmetic processing in the output registers.

13. The arithmetic processing method according to claim 12, further comprising:
providing the output registers adapted to include a first output register and a second output register;
allocating the first output register to the first arithmetic processing unit; and
allocating the second output register to the second arithmetic processing unit,
the first arithmetic processing unit storing a processing result of the first arithmetic processing in the first output register and the second arithmetic processing unit storing a processing result of the second arithmetic processing in the second output register.

14. The arithmetic processing method according to claim 12, wherein, irrespectively of a decoding result of fetched instruction data, in each of the execution cycles, the first arithmetic processing unit and the second arithmetic processing unit store arithmetic operation results of the arithmetic processing units in the output registers corresponding thereto.

15. The arithmetic processing method according to claim 12, wherein the instruction data is instruction data corresponding to a data transfer instruction and a branch instruction excluding an arithmetic operation instruction, a logical operation instruction, and a shift operation instruction.

16. The arithmetic processing method according to claim 12, wherein the input registers are general-purpose registers.

17. The arithmetic processing method according to claim 12, wherein the output registers are accumulators.

18. The arithmetic processing method according to claim 12, wherein the first arithmetic processing unit and the second arithmetic processing unit are configured to be operable in parallel to each other.

19. An electronic apparatus comprising:
a memory that stores a computer program and data; and
the information processing device according to claim that performs arithmetic processing corresponding to the computer program and the data.

20. A projector including a projecting unit that projects an image corresponding to inputted image data, comprising:
a memory that stores a computer program and data,
the image processing device includes the information processing device according to claim 1 that performs arithmetic processing corresponding to the computer program and the data.
